(19) United States
(12) Patent Application Publication
(10) Pub. No.: US 2006/0172105 A1
(43) Pub. Date: Aug. 3, 2006

(54) Method and apparatus for displaying a document

(75) Inventor: Janeen A. Johnson, Brodhead, WI (US)

Correspondence Address: REINHART BOERNER VAN DEUREN P.C., 483 NORTH MULFORD ROAD, SUITE 7, ROCKFORD, IL, 61107, US

(73) Assignee: PDU LAD Corporation, d/b/a The LAD Company, Rockford, IL (US)

(21) Appl. No.: 11/336,518

(22) Filed: Jan. 20, 2006

Related U.S. Application Data
(60) Provisional application No. 60/648,321, filed on Jan. 28, 2005.

(51) Int. Cl. B32B 33/00

(52) U.S. Cl. 428/42.3

(57) ABSTRACT

A method and apparatus are provided for displaying one or more documents, and/or other visual elements, on a substrate, through the use of an apparatus including the substrate, and at least one document holder that is selectively attachable to the substrate with one or more removable adhesive pads. The adhesive pads may also be re-usable in some embodiments. The document holders and/or substrate may be reversible with different visual appearance on opposite sides thereof. The document holders and/or substrate may have recognizable shapes or appearances, such as sports equipment, pennants, clouds, text balloons, etc.

### CROSS-REFERENCE TO RELATED PATENT APPLICATIONS

This patent application claims the benefit of U.S. Provisional Patent Application No. 60/648,321, filed Jan. 28, 2005, the disclosure and teachings of which are incorporated herein in their entireties by reference.

### FIELD OF THE INVENTION

This invention relates generally to the display of documents or other visual elements, such as certificates, photographs, or artwork, and more particularly to an apparatus and method for displaying documents in a holder attached to a substrate.

### BACKGROUND OF THE INVENTION

Documents, such as certificates, photographs and artwork are often mounted onto a substrate, in the form of a rigid plaque, along with other visual elements, for display on a vertical surface, such as a wall, or standing on a horizontal surface, such as a shelf or a desk top. It is desirable that an apparatus and method be provided for attractively and conveniently creating such displays of one or multiple documents on a single substrate. It is also desirable that such an apparatus and method be capable of being provided in the form of a kit, or as piece parts, that can be assembled by a user to form a customized display. It is further desirable that such a display be changeable, by the user, from time-to-time, with the component parts of the display apparatus being re-usable and re-configurable into a variety of forms.

Prior approaches to providing such displays are not entirely satisfactory. For example, in one widely utilized prior approach, a display apparatus includes a plaque, a document cover sheet of transparent material, and several fasteners, such as decorative brads or screws, for permanently attaching the cover sheet to the plaque. The plaque and cover sheet are pre-drilled with corresponding holes for the fasteners, so that once the document is affixed to the plaque and the cover sheet is positioned over the document with the holes in the cover sheet aligned with the holes in the plaque, the fasteners can be inserted through the holes in the cover sheet and into the pre-drilled holes in the plaque, to thereby affix the cover sheet in place over the document.

This approach has several drawbacks, however. Experience has shown that it is often difficult to complete attachment of the fasteners without bending them, and/or breaking the corners off of the cover sheet. It is also generally not possible to remove the fasteners, to change the display, once the fasteners are completely inserted into the pre-drilled holes. Furthermore, the final form of the display is generally limited to one pre-determined configuration, by the location and number of the pre-drilled holes provided by the manufacturer of the display apparatus.

What is needed, therefore, is an improved method and an apparatus for displaying single or multiple documents, or other visual elements, on a single substrate, in a manner meeting one or more of the desired attributes, or overcoming one or more of the problems described above.

### BRIEF SUMMARY OF THE INVENTION

The invention provides a method and apparatus for displaying one or more documents, or other visual elements, on a substrate, through the use of an apparatus including the substrate, and at least one document holder that is selectively attachable to the substrate with one or more removable adhesive pads. In some forms of the invention, the adhesive pads may also be re-usable.

In one form of the invention, one or more document holders may be formed as a folded sheet of at least partially transparent material, having a front and a rear thereof, joined by a U-shaped bight along a portion of the edges of the front and rear legs of the holder. The rear leg includes a rear surface thereof which is adapted for attachment to the substrate by the removable adhesive pads, and a front leg provides a cover sheet over the document, when the document is inserted into the space between the front and rear legs of the holder.

In some forms of the invention, the holder may have a first and a second leg joined by a U-shaped bight, with both the first and second legs being usable as either the front or the rear leg, so that the holder is reversible. The first and second legs may have different tinting, coloration, or designs pre-printed thereupon, so that the user may select either the first or the second leg as the front side of the holder by simply reversing the holder on the substrate.

In other forms of the invention, the holder may be single layer of partially transparent material, including an opaque or translucent area over the adhesive pads, so that the pads are not visible once the holder is attached to the substrate. The holder may also include a securing element, such as a lip, tangs, or a stepped rear surface, for holding the document in place against the substrate, without the document being attached to the substrate.

The holders and plaques may take many regular and irregular shapes, including rectangular, round, oval, star-shaped, and amorphous shapes. The holders and substrates may also be made in virtually any size. For displays relating to sports, for example, the plaques and holders may take recognizable representative shapes, such as a home plate, or a baseball bat, a cheerleader's megaphone, a football, or a hockey stick. The holders may also include matting or designs to represent recognizable elements such as a soccer ball, or other types of round balls used in various sports. Amorphous shapes may include cloud-shapes, or text-balloons like those used in cartoon strips. In some forms of the invention, the plaques and holders are custom shaped, to match a design provided by the user. The shape of plaques and holders, according to the invention, is limited only by the imagination of the manufacturer and user.

In embodiments where the holders are asymmetrically shaped, such as a sports pennant, a baseball bat, a cheerleader's megaphone, or a hockey stick, for example, forming the holders with reversible first and second legs joined by a U-shaped bight, as described above, provides the option of reversing the direction of the displayed surface (i.e. the position of the pointed end of a pennant, for example) while still keeping the U-shaped bight at the bottom of the holder to provide maximum support for the bottom edge of the document.

As will be understood by those having skill in the art, the invention allows a user to readily create a display customized to their own unique tastes and needs. A document in the document holder can be easily removed and replaced over time, because it is not necessary to affix the document to the substrate. The holder can also be removed from the substrate, or repositioned thereupon. Additional holders can be added, and moved over time, to display additional documents on the same substrate, or a new substrate may be utilized with the original holders.

The substrate may have different finishes or colors on the front and back sides thereof, so that the substrate is reversible. For example, the front side of the substrate may be finished in a light color, and the back side in a dark color. For sports related displays, where a team is identified by a combination of two colors, such as purple and white, for example, one side of the substrate may be purple and the other white.

In some forms of the invention, the back side of the substrate includes keyhole slots, or other features allowing the substrate to be hung from a nail or other hanger protruding from a vertical wall. In some embodiments of the invention, and preferably in those embodiments that include a reversible substrate, the invention may include one or more hangers that are attachable to the back of the substrate with the same sort of removable, and also re-usable in some embodiments, adhesive pads used for attaching the holders to the front of the substrate, for hanging the substrate on a vertical surface. Some forms of the invention may utilize a support stand, or leg, attachable to the back of the substrate with screws or other fasteners, or with the same sort of removable, and also re-usable in some embodiments, adhesive pads used for attaching the holders to the front of the substrate.

In some forms of the invention, other types of visual elements, such as an engraved name plate, or other opaque plates or figures, may also be attached to the substrate with double-sided pads, in the same manner as the holders. An apparatus, according to the invention may also include a blank document, configured for insertion into a holder according to the invention, which can be filled in by the user.

An apparatus or method, according to the invention, may also include one or more templates to facilitate marking and/or cutting a document to a shape and size required for use with a particular shape and size of holder. The invention may also include utilization of a computer and instructions in a computer readable medium for producing visual elements, such as documents, photos, or images having a shape and size configured for use with a holder according to the invention.

The component parts of an apparatus, according to the invention, may take the form of a kit, or be supplied as separately marketed components which the user can selectively purchase to tailor a display to their particular needs and fancy.

Other aspects, objects and advantages of the invention will be apparent from the following description of the invention, in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is an exploded perspective illustration of an exemplary embodiment of a display apparatus according to the invention.

FIGS. 2A-2F are enlarged cross sections showing alternate configurations of a second holder of the apparatus shown in FIG. 1.

FIGS. 3A-3G illustrate the component parts and method of assembling a second embodiment of a display apparatus, according to the invention.

FIG. 4A illustrates a number of shapes that may be selected for holders, substrates, and displays, according to the invention.

FIG. 4B shows an embodiment of the invention having a number of holders of various shapes attached to a single rectangular-shaped substrate.

While the invention will be described in connection with certain preferred embodiments, there is no intent to limit it to those embodiments. On the contrary, the intent is to cover all alternatives, modifications and equivalents as included within the spirit and scope of the invention.

### DETAILED DESCRIPTION OF THE INVENTION

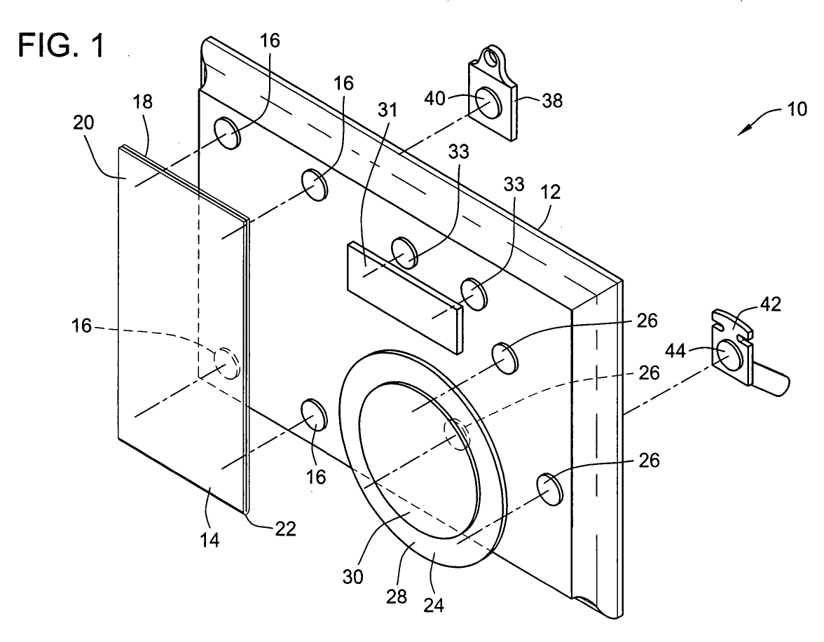

FIG. 1 shows a first exemplary embodiment of the invention, in the form of a display apparatus 10, for displaying one or more documents on a vertical or a horizontal surface. The display apparatus 10 includes a substrate 12, a first holder 14, and one or more double-sided adhesive pads 16 for removably attaching the holder 14 to the substrate 12. Preferably, the adhesive pads 16 are also re-usable.

The substrate 12 can be fabricated from a variety of natural and man-made materials, such as wood, plastic, metal, marble, cardboard, glass, luan, medium density fiberboard, other composite materials, or combinations of such materials. The substrate 12 may be coated or covered with a decorative laminate, foil, paper, or other material, in the manner know in the art. For example, one suitable substrate could be a ⅝ inch thick plaque formed from medium density fiberboard, having a foiled cove edge profile, laminated with a 30 gram re-coatable covering in a cherry finish, with two key slots routed into the back side of the plaque to allow the plaque to be attached to a vertical surface in either of two orientations. Such plaques are available from the LAD Company, of Rockford, Ill.

The first holder 14 is a folded sheet of transparent material having a first and a second leg 18, 20, joined along one edge by a U-shaped bight 22. As shown in FIG. 1, the first leg 18 is positioned to function as a rear leg, for attachment to the substrate 12 by the adhesive pads 16, with the second leg 20 of the first holder 14 forming a front leg and a display surface through which a document (not shown), inserted into the space between the front and rear legs 20, 18, may be viewed. The U-shaped bight 22 of the first holder 14 is positioned along the bottom edge of the legs 18, 20 of the first holder 14, to provide maximum support for a document inserted into the first holder 14.

The first holder 14 of the display apparatus 10 is formed from 0.040 inch thick PETG material, but in other embodiments of the invention, other suitable materials may also be utilized. PETG material is available from JMK displays, of Darien Center, New York.

The adhesive pads 16 are 1/16 inch thick, ¾ inch thick, round re-usable double-sided foam adhesive, of the type supplied by Valley Industrial Supplies, of Huntington, N.Y. It will be understood, however, that other sizes of adhesive pads may be used for the pads 16, or in attaching any holder, or other object, to the substrate in accordance with the teachings of the invention.

The exemplary embodiment of a display apparatus 10 shown in FIG. 1 also includes a second holder 24 attached to the substrate 12 by removable and reusable double sided adhesive pads 26, in the same manner as described above in relation to the first holder 14, for holding a second document (not shown). The adhesive pads 26 used for attaching the second holder 24 may, or may not, be the same size and shape as the adhesive pads 16 used for attaching the first holder 14 to the substrate 12.

The second holder 24 is a single layer of transparent material, having an opaque, matted-looking outer rim 28, surrounding a viewing window 30 through which the second document can be viewed. The adhesive pads 26, attaching the second holder 24 to the substrate 14, are attached to the back side of the outer rim 28, so that they are not visible through the viewing window 30 of the second holder 24. One or more of the adhesive pads 26 may also be further positioned toward the bottom of the second holder 24, to support the second document within the second holder 24, where it is desirable to not have the second document attached to either the substrate 12 or the back side of the second holder 24.

FIG. 1 also shows an opaque item, in the form of an engraved nameplate 31, attached to the substrate 12 with double-sided pads 33, in the same manner as the first and second holders 14, 24.

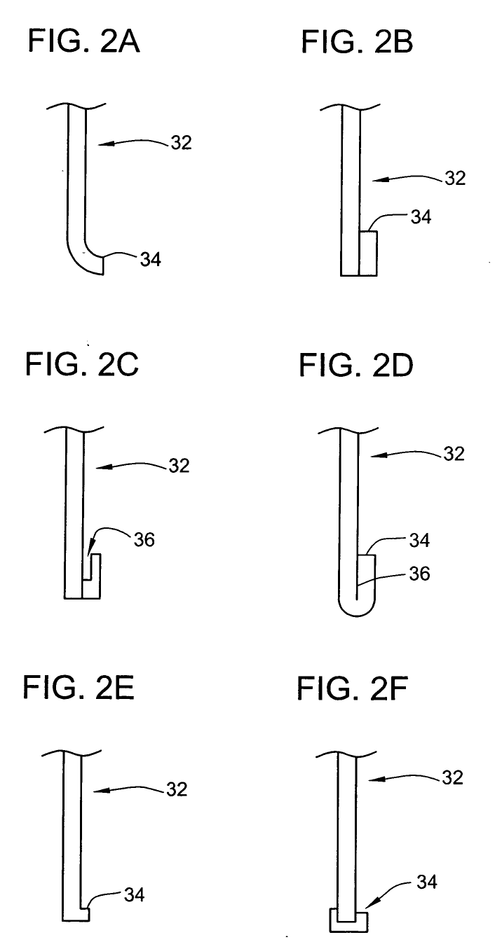

FIGS. 2A-2F illustrate several alternate embodiments of a holder 32, according to the invention, having a lip 34 or slot 36 in the back side of the holder 32 for receiving or supporting edge of a document, so that the document does not need to be attached to either the substrate 12 or the holder 32. Many other variations are also possible within the scope of the invention.

As shown in FIG. 1, a display apparatus 10, according to the invention, may include one or more hangers 38 that are attachable to the back of the substrate 12 with the same sort of removable, and also re-usable in some embodiments, adhesive pads 40 used for attaching the holders 14, 24 to the front of the substrate 12, for hanging the substrate 12 on a vertical surface. The apparatus 10 may, alternatively utilize a support stand 42, or leg, attachable to the back of the substrate 12 with screws or other fasteners (not shown) in the manner known in the art, or with the same sort of removable, and also re-usable in some embodiments, adhesive pads 44 used for attaching the holders 14, 24 to the front of the substrate 12.

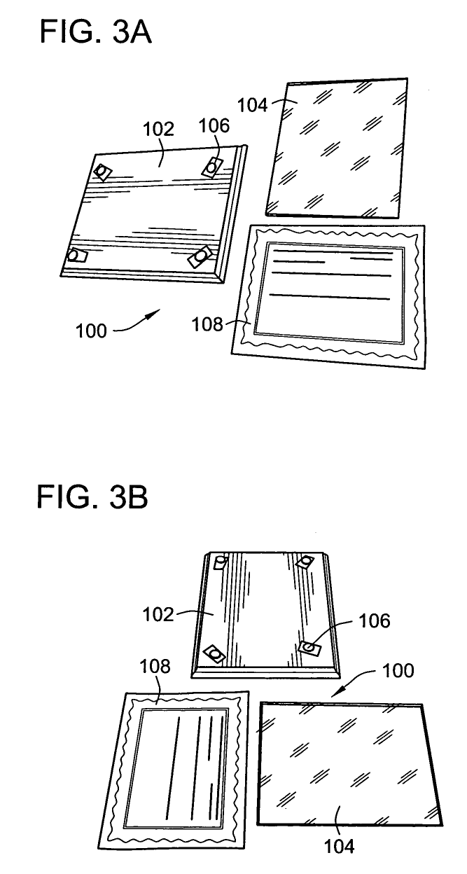

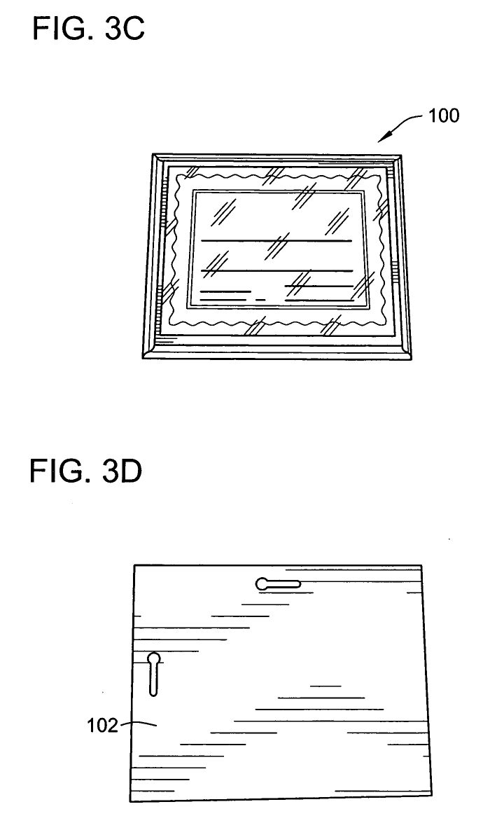

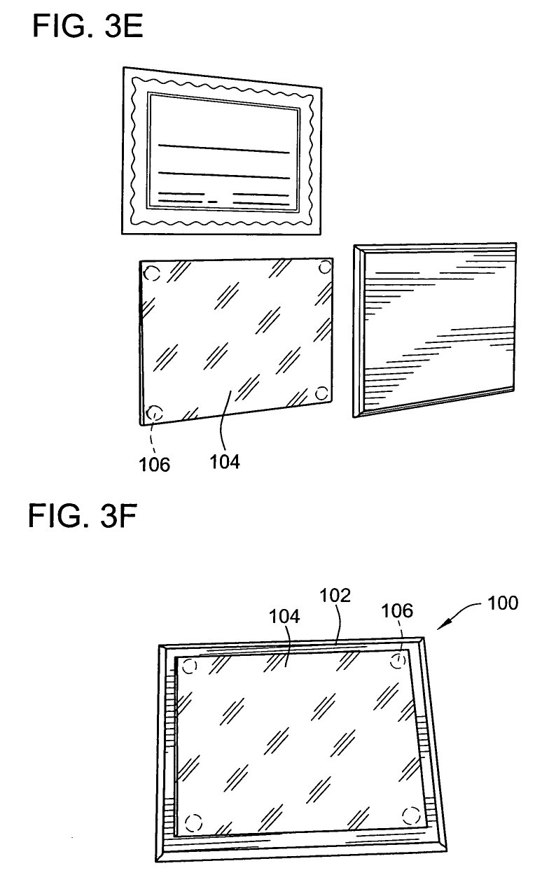

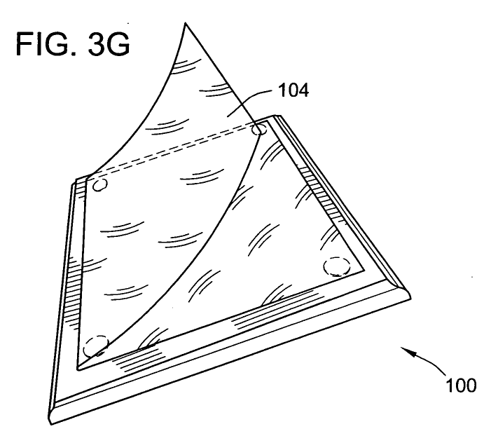

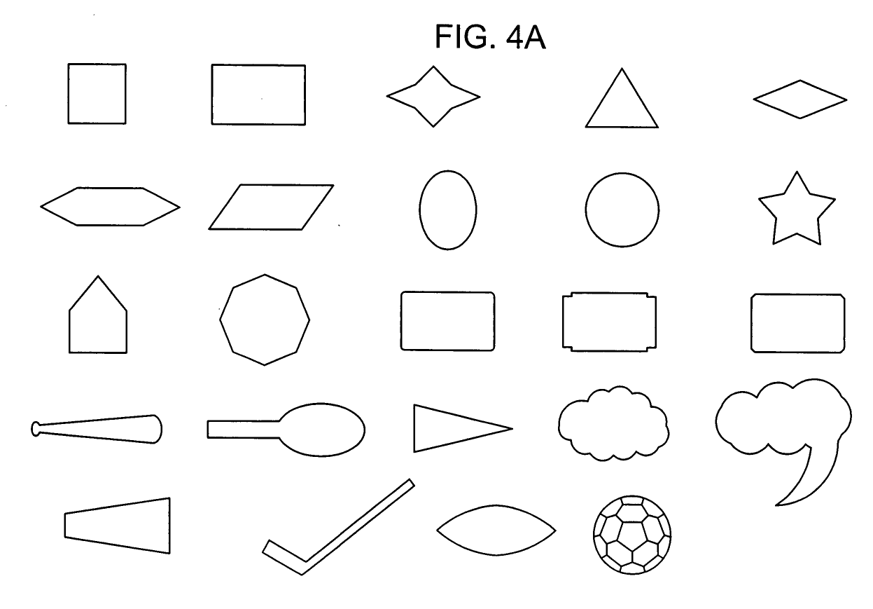

FIGS. 3A-3G are photographs showing the component parts of an actual display apparatus 100, according to the invention, and illustrating the manner in which they are assembled to form the final display shown in FIG. 3C. Specifically, the display apparatus 100 includes a substrate 102, a holder 104, four adhesive pads 106 for attaching the holder 104 to the substrate 102, and an award certificate 108 for display in the holder.

The substrate 102 is a ⅝ inch thick, rectangular-shaped plaque of medium density fiberboard, having a decorative cove along the edges of the front side of the plaque, and completely covered in a layer of cherry wood-grain foil laminate. As shown in FIG. 3D, the rear side of the substrate 102 includes two keyhole slots, to allow the substrate 102 to be hung in one of two alternate orientations on a vertical surface.

The holder 104 is a folded sheet of 0.040 thick transparent PETG material having a first and a second leg, joined along one edge by a U-shaped bight, in the manner described above in relation to the first holder 14 of the exemplary embodiment shown in FIG. 1. The first and second legs of the holder 104 are identical to one another, so that the holder 104 is reversible.

The adhesive pads 106 are 1/16 inch thick, ¾ inch round, re-usable double-sided foam adhesive. As shown in FIGS. 3A and 3B, both sides of the pads 106 are initially covered by a protective covering strip to keep the pads 106 from inadvertently becoming bonded to a surface, and to protect the adhesive on the pads from becoming covered with dirt.

As shown in FIGS. 3E and 3F, the protective covering is removed from the pads 106, and they are positioned and pressed into place on the back leg of the holder 104. The holder 104 is then inverted, and pressed against the substrate 102, to attach the holder 104 to the substrate 102.

The front leg of the holder 104 may then be raised, as shown in FIG. 3G, so that the certificate 108 can be inserted in to the holder 104, for display as shown in FIG. 3C.

The use of the terms “a” and “an” and “the” and similar referents in the context of describing the invention are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “visual elements,” is intended to include, but not be limited to, document holders, and other items such as engraved nameplates, opaque plates, photographs, images or figures, which may be included in practicing the invention.

Recitation of ranges of values herein are merely intended to serve as a shorthand method of referring individually to each separate value falling within the range, unless otherwise indicated herein, and each separate value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed.

No language in the specification should be construed as indicating any element not expressly described herein as being essential to the practice of the invention.

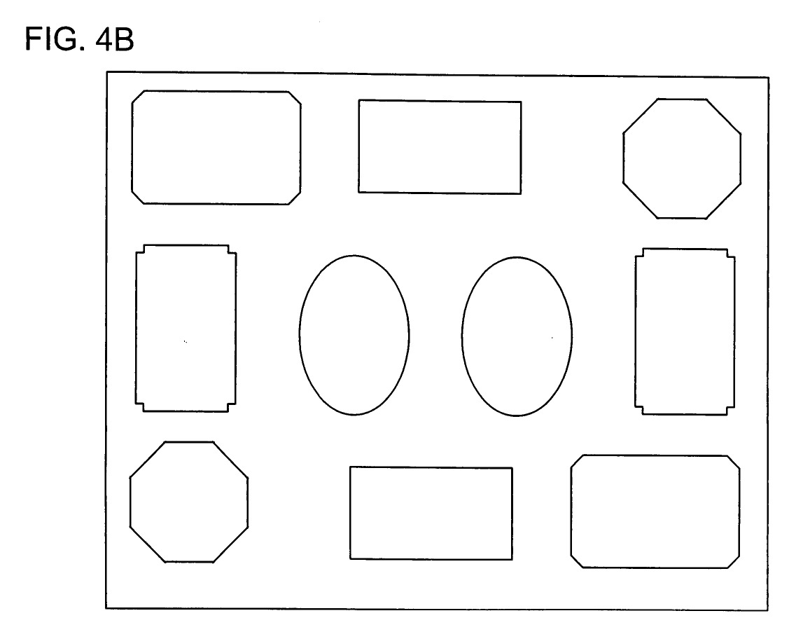

Preferred embodiments of this invention are described herein, including the best mode known to the inventor for carrying out the invention. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. For example, FIG. 4A illustrates a small number of the virtually unlimited alternate shapes that can be used for holders, and/or substrates, according to the invention. FIG. 4B shows an embodiment of the invention having a number of holders of various shapes attached to a single rectangular-shaped substrate.

Accordingly, this invention includes all modifications and equivalents of the subject matter recited or suggested herein as permitted by applicable law. Moreover, any combination of the above-described elements in all possible variations thereof is encompassed by the invention unless otherwise indicated herein or otherwise clearly contradicted by context.

What is claimed is:

1. A display apparatus for displaying one or more documents, the display apparatus comprising:
a substrate;
one or more removable adhesive pads; and
at least one document holder that is selectively and removably attachable to the substrate with the removable adhesive pads.

2. The display apparatus of claim 1, wherein, the substrate is a plaque adapted for display on a surface.

3. The display apparatus of claim 1, wherein, the substrate is reversible, having first and second oppositely facing faces thereof, with the first and second faces having visual appearances differing from one another, and with both the first and second faces being adapted for attachment thereto of the document holder with the one or more removable adhesive pads.

4. The display apparatus of claim 1, further comprising, a template for facilitating marking and/or cutting a visual element to a shape and size required for use with the document holder.

5. The display apparatus of claim 1, further comprising, at least one computer readable medium including computer executable instructions for producing a visual element configured for use with the at least one document holder.

6. The display apparatus of claim 1, wherein, the removable adhesive pads are re-usable for attaching the at least one document holder to the substrate.

7. The display apparatus of claim 1, wherein one or more of the at least one document holders comprises a folded sheet of at least partially transparent material, having a front and a rear thereof, with the front and rear legs each defining respective edges thereof joined to one another along a portion of the respective edges of the front and rear legs by a U-shaped bight.

8. The display apparatus of claim 7, wherein, the document holder includes a first and a second leg joined by the U-shaped bight, with either of the first and/or second legs being usable as the front or the rear leg, so that the document holder is reversible in its attachment to the substrate.

9. The display apparatus of claim 8, wherein, the first and second legs have a different appearance from one another.

10. The display apparatus of claim 8, wherein the holder is asymmetrically shaped in a manner allowing the asymmetrically shaped holder to be attached to the substrate in at least two oppositely directed orientations.

11. The display apparatus of claim 10, wherein the U-shaped bight remains positioned along a lower edge of the holder, when the holder is positioned in either of the two oppositely directed orientations.

12. The display apparatus of claim 1, wherein, the holder comprises, a single sheet of at least partially transparent material, including an opaque or translucent area for positioning over the adhesive pads, so that the pads are not noticeably visible once the holder is attached to the substrate.

13. The display apparatus of claim 12, wherein, the single sheet further comprises a securing element for holding the document in place against the substrate, without having the document otherwise attached to the substrate.

14. A display apparatus for displaying one or more visual elements, the display apparatus comprising:
a substrate;
one or more removable adhesive pads; and
at least one visual element that is selectively and removably attachable to the substrate with the removable adhesive pads.

15. The display apparatus of claim 14, wherein, the substrate is a plaque adapted for display on a surface.

16. The apparatus of claim 15, further comprising a kit consisting essentially of at least one of the group of the substrate, the one or more removable adhesive pads, and the visual element.

17. The apparatus of claim 15, wherein, the visual element is an opaque plate.

18. The apparatus of claim 15, wherein, the visual element is a document holder.

19. The display apparatus of claim 18, wherein one or more of the at least one document holders comprises a folded sheet of at least partially transparent material, having a front and a rear thereof, with the front and rear legs each defining respective edges thereof joined to one another along a portion of the respective edges of the front and rear legs by a U-shaped bight.

20. A method for displaying one or more visual elements on a movable substrate, the method comprising, removably attaching at least one visual element to the substrate with one or more removable adhesive pads.

21. The method of claim 20, wherein, the substrate is a plaque adapted for display on a surface, and the method further comprises placing the plaque on the surface.

22. The method of claim 21, further comprising, providing one or more of the plaque, the adhesive pads, and the visual element as a kit consisting essentially of at least one of the group of the substrate, the one or more removable adhesive pads, and the visual element.

23. The method of claim 20, further comprising, providing a visual element in the form of a document holder comprising a folded sheet of at least partially transparent material, having a front and a rear thereof, with the front and rear legs each defining respective edges thereof joined to one another along a portion of the respective edges of the front and rear legs by a U-shaped bight.

24. The method of claim 23, further comprising, configuring the document holder to include a first and a second leg joined by the U-shaped bight, with either of the first and/or second legs being usable as the front or the rear leg, so that the document holder is reversible in its attachment to the substrate.

25. The method of claim 24, further comprising, configuring the first and second legs have a different appearance from one another.

26. The method of claim 25, further comprising, configuring the document holder to be asymmetrically shaped, in a manner allowing the asymmetrically shaped holder to be attached to the substrate in at least two oppositely directed orientations.

27. The method of claim 26, further comprising, configuring the document holder in such a manner that the U-shaped bight may remain positioned along a lower edge of the holder, when the holder is positioned in either of the two oppositely directed orientations.

28. The method of claim 20, further comprising, marking and/or cutting a visual element, in accordance with a template corresponding to the document holder, to a shape and size required for use with the document holder.

29. The method of claim 20, further comprising, using computer executable instructions and a computer for producing a visual element configured for use with the at least one document holder.
